(19) United States
(12) Patent Application Publication
(10) Pub. No.: US 2024/0161005 A1
(43) Pub. Date: May 16, 2024

(54) ADD-ON TO A MACHINE LEARNING MODEL FOR INTERPRETATION THEREOF

(71) Applicant: Medial EarlySign Ltd., Kfar-Malal (IL)

(72) Inventors: Yaron KINAR, Tel-Aviv (IL); Avi SHOSHAN, Mazkeret Batia (IL); Alon LANYADO, Herzeliya (IL); Yaacov METZGER, Hod Hasharon (IL)

(73) Assignee: Medial EarlySign Ltd., Kfar-Malal (IL)

(21) Appl. No.: 18/279,603

(22) PCT Filed: Mar. 1, 2022
(86) PCT No.: PCT/IL2022/050225

§ 371 Date: Aug. 31, 2023

Related U.S. Application Data
(60) Provisional application No. 63/154,885, filed on Mar. 1, 2021.

(51) Int. Cl. G06N 20/00

(52) U.S. Cl. CPC G06N 20/00

(57) ABSTRACT

There is provided an add-on component configured for: receiving features and an outcome of an ML model, wherein at least two of the features are correlated by a covariance value above a threshold, computing, for each of the features, a respective contribution coefficient denoting an initial value, identifying a certain feature with highest contribution coefficient indicative of a relative contribution to the outcome, computing, for a subset of features that are non-independent with respect to the certain feature, a respective subsequent value for the contribution coefficient by adjusting the respective initial value according to a covariance with the contribution coefficient of the certain feature, iterating the identifying and the computing to compute a subsequent certain feature with highest contribution coefficient for the remaining features, and re-adjusting the respective contributing coefficient according to a covariance with the contribution coefficient of the subsequent certain feature, and providing the respective contribution coefficient(s).

### RELATED APPLICATION/S

This application claims the benefit of priority of U.S. Provisional Patent Application No. 63/154,885 filed on 1 Mar. 2021, the contents of which are incorporated herein by reference in their entirety.

### FIELD AND BACKGROUND OF THE INVENTION

The present invention, in some embodiments thereof, relates to add-ons to machine learning models and, more specifically, but not exclusively, to systems and methods for interpretation of an outcome of the machine learning model.

Many machine learning models operate as black boxes, where provided input is fed into the machine learning model, and an outcome is generated. Courses of action taken based on the outcome may be significant, for example, a patient may be sent for testing when the machine learning model indicates risk of cancer, and/or a production system may be shut down for further investigation when the machine learning model indicates a risk of system malfunction. Therefore, different approaches have been developed to improve the experience of the user interacting with the machine learning model, to help interpret the outcome, by providing the user with an indication of which features fed into the machine learning model are the most influential on the outcome.

### SUMMARY OF THE INVENTION

According to a first aspect, an add-on component to a system executing a machine learning (ML) model, comprises at least one hardware processor executing a code for: receiving a plurality of features and an outcome of the ML model generated in response to an input of the plurality of features, wherein at least two of the plurality of features are correlated to each other by a covariance value above a threshold, computing a respective contribution coefficient denoting an initial value, for each of the plurality of features, analyzing the plurality of features to identify a certain feature with highest contribution coefficient indicative of a relative contribution of the certain feature to the outcome, computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature, iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature, and providing the respective contribution coefficient for each of the plurality of features.

According to a second aspect, a method for interpreting an outcome of a ML model, comprises: receiving a plurality of features and an outcome of the ML model generated in response to an input of the plurality of features, wherein at least two of the plurality of features are correlated to each other by a covariance value above a threshold, computing a respective contribution coefficient denoting an initial value, for each of the plurality of features, analyzing the plurality of features to identify a certain feature with highest contribution coefficient indicative of a relative contribution of the certain feature to the outcome, computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature, iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature, and providing the respective contribution coefficient for each of the plurality of features.

According to a third aspect, a computer program product for interpreting an outcome of a ML model comprising program instructions which, when executed by a processor, cause the processor to perform: receiving a plurality of features and an outcome of the ML model generated in response to an input of the plurality of features, wherein at least two of the plurality of features are correlated to each other by a covariance value above a threshold, computing a respective contribution coefficient denoting an initial value, for each of the plurality of features, analyzing the plurality of features to identify a certain feature with highest contribution coefficient indicative of a relative contribution of the certain feature to the outcome, computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature, iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature, and providing the respective contribution coefficient for each of the plurality of features.

In a further implementation of the first, second, and third aspects, further comprising: computing a feature decision tree including a plurality of connected nodes, each respective node denoting a respective at least one feature of the plurality of features indicating a decision at the respective node based on the respective at least one feature, wherein a path along edges connecting nodes extending from a common root to a respective leaf denote an increasing number of features and a respective combination of decisions that arrive at a certain predicted outcome of the ML model represented by the respective leaf and nodes along the path, wherein the respective contribution coefficient is updated for respective features represented by respective nodes of the feature decision tree.

In a further implementation of the first, second, and third aspects, the respective contribution coefficient of the respective feature is adjusted according to the covariance with the contribution coefficient of the certain feature, comprises: multiplying a coefficient vector including a plurality of the respective contribution coefficients of the plurality of features, by a covariance matrix computed from a training dataset storing training features labelled with a training outcome used to train the ML model.

In a further implementation of the first, second, and third aspects, iterating comprises applying a condition that when a predefined number of certain features with highest contribution coefficients are computed, a new feature decision tree is generated, and wherein for each respective node with a respective decision made on a respective computed highest contribution coefficient, the respective node is removed and an edge going into the node is joined to an edge going out of the node corresponding to the respective feature.

In a further implementation of the first, second, and third aspects, computing the initial value for the respective contribution coefficients for each of the plurality of features comprises: in a plurality of iterations: selecting a respective subset of the plurality of features, wherein the subset of the plurality of features represent an incomplete set of features of a feature vector, wherein in each iteration another subset is selected, generating a plurality of completion features by inputting the subset of the plurality of features into a sample generator that computes artificial completion features, generating a complete feature vector that includes the subset of the plurality of features and the plurality of completion features, inputting the complete feature vector into the ML model, obtaining a complete outcome of the ML model in response to the input of the complete feature vector, and computing the initial value for each respective contribution coefficient of the features of the subset using the corresponding complete outcome, wherein the iterations are performed for each respective subset of a plurality of subset of the plurality of features using the respective complete outcome of the ML model.

In a further implementation of the first, second, and third aspects, the respective contribution coefficient of the respective feature of the respective selected subset of features is adjusted according to the covariance with the contribution coefficient of the certain feature of the respective selected subset, comprises: multiplying a coefficient vector including a plurality of the respective contribution coefficients of the selected subset, by a covariance matrix computed from a training dataset storing training features labelled with a training outcome used to train the ML model.

In a further implementation of the first, second, and third aspects, for a first predefined number of selected features, masks fed into the sample generator are selected to include the selected features.

In a further implementation of the first, second, and third aspects, computing the initial value for the respective contribution coefficients for each of the plurality of features comprises: generating matrix having a first number of columns corresponding to a number of the plurality of features, and a second number of rows, for each respective row: selecting a respective subset of the plurality of features, wherein non-selected features are denoted as incomplete features, inputting the selected subset of the plurality of features into a sample generator that computes artificial completion features, storing the artificial completion features at the location of the incomplete features, wherein each respective row is associated with a binary indicator vector, generating a feature vector including the selected subset of the plurality of features and the artificial completion features, inputting the feature vector into the ML model, obtaining a complete outcome from the ML model fed the feature vector, computing the initial value of the respective contribution coefficient for each respective feature of each respective row by applying a linear least-square process to the matrix.

In a further implementation of the first, second, and third aspects, further comprising code for: clustering the plurality of features into a plurality of clusters, wherein each respective cluster includes a subset of at least two features of the plurality of features, wherein the plurality of clusters are mutually exclusive and exhaustive, analyzing the plurality of clusters to identify a certain cluster with highest contribution set coefficient indicative of a relative contribution of the certain cluster to the outcome, computing, for each respective cluster of a subset of the plurality of clusters that are non-independent with respect to the certain feature, a respective set contribution coefficient by adjusting the respective set contribution coefficient of the respective cluster according to a covariance with the set contribution coefficient of the certain feature, iterating the analyzing and the computing to compute a subsequent certain cluster with highest set contribution coefficient for the remaining plurality of clusters excluding the previous certain cluster, and re-adjusting the respective set contributing coefficient according to a covariance with the set contribution coefficient of the subsequent certain cluster, and providing the respective set contribution coefficient for each of the plurality of clusters.

In a further implementation of the first, second, and third aspects, wherein computing, for each respective cluster of the subset of the plurality of clusters that are non-independent with respect to the certain feature, the respective set contribution coefficient by considering nodes where a respective location decision is based on a feature denoted i∈G as corresponding to G, in a process comprising traversing nodes in a feature decision tree and updating contribution coefficients denoted ϕᵢ according to nodes where a local decision is based on a respective feature denoted i, wherein a number of samples going through each split at each respective node is maintained by the tree to estimate fₓ(S).

In a further implementation of the first, second, and third aspects, the respective set contribution coefficient of the respective cluster is adjusted according to the covariance with the set contribution coefficient of the certain cluster, comprises: multiplying a set coefficient vector including a plurality of the respective set contribution coefficients of the plurality of clusters and a plurality of respective contribution coefficients of the plurality of features, by a set covariance matrix computed from a training dataset storing training features labelled with a training outcome used to train the ML model.

In a further implementation of the first, second, and third aspects, computing the initial value for the respective contribution coefficients for each of the plurality of features comprises: in a plurality of iterations: selecting a respective subset of features from the plurality of clusters, wherein the subset of features represent an incomplete set of features of a feature vector, wherein in each iteration another subset is selected, generating a plurality of completion features by inputting the subset of features into a sample generator that computes artificial completion features, generating a complete feature vector that includes the subset of features and the plurality of completion features, inputting the complete feature vector into the ML model, obtaining a complete outcome of the ML model in response to the input of the complete feature vector, and computing the initial value for each set of contribution coefficients for the plurality of clusters using the corresponding complete outcome.

In a further implementation of the first, second, and third aspects, computing the initial value for the respective contribution coefficients for each of the plurality of features comprises: generating matrix having a first number of columns corresponding to a number of the plurality of clusters, and a second number of rows, for each respective row: selecting a respective subset of the plurality of features from the plurality of clusters, wherein non-selected features are denoted as incomplete features, inputting the selected subset of the plurality of features into a sample generator that computes artificial completion features, storing the artificial completion features at the location of the incomplete features, wherein each respective row is associated with a binary indicator vector, generating a feature vector including the selected subset of the plurality of features and the artificial completion features, inputting the feature vector into the ML model, obtaining a complete outcome from the ML model fed the feature vector, and computing the initial value for the respective contribution coefficient for each respective cluster of each respective row by applying a linear least-square process to the matrix.

In a further implementation of the first, second, and third aspects, at least two of the plurality of features that are correlated to each other are extracted from a same set of raw data elements.

In a further implementation of the first, second, and third aspects, the raw data elements include blood tests results selected from a group consisting of: red blood cell test results, white blood cell test results, platelet blood test results.

In a further implementation of the first, second, and third aspects, extracted comprises aggregating a time sequence of data elements with different time stamps, and/or mathematical functions applied to a combination of two or more different data elements.

In a further implementation of the first, second, and third aspects, aggregating and/or mathematical functions are selected from a group consisting of: average, minimal value, and maximal value.

In a further implementation of the first, second, and third aspects, the at least two of the plurality of features that are correlated to each other have a covariance value above about 0.7.

In a further implementation of the first, second, and third aspects, a number of the plurality of features extracted from a set of raw data elements is at least 256.

In a further implementation of the first, second, and third aspects, further comprising: identifying at least one of the plurality of features with respective contribution coefficient that trigger a significant change of the outcome when the identified at least one feature is changed, generating instructions for adjustment of the identified at least one feature for significantly changing the outcome generated by the ML model from one classification category to another classification category.

In a further implementation of the first, second, and third aspects, the outcome comprises an undesired medical condition, the instructions are for treating the patient to change the outcome from the undesired medical condition to lack of the undesired medical condition by administering a medication to reduce the value of the identified at least one feature.

In a further implementation of the first, second, and third aspects, the outcome comprises a prediction of likelihood of failure of an electrical and/or mechanical and/or computer system, wherein the plurality of features includes measurements of components of the system, and the instructions are for reducing risk of system failure by improving operation of a component having a measurement that most contributes to likelihood of failure of the system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system that includes an add-on to a ML model for interpreting outcomes of the ML model based on features inputted into the ML model, in accordance with some embodiments of the present invention;

FIG. 2 is a flowchart of a method for interpreting outcomes of the ML model based on features inputted into the ML model, in accordance with some embodiments of the present invention;

FIG. 3 is a dataflow diagram of an exemplary dataflow for computing respective contribution coefficients of features inputted into a ML model for generating an outcome, in accordance with some embodiments of the present invention;

FIG. 4 is an exemplary GUI presenting relative contribution coefficients of features, in accordance with some embodiments of the present invention; and

FIG. 5 is another exemplary GUI presenting relative contribution coefficients of features, in accordance with some embodiments of the present invention.

### DESCRIPTION OF SPECIFIC EMBODIMENTS OF THE INVENTION

The present invention, in some embodiments thereof, relates to add-ons to machine learning models and, more specifically, but not exclusively, to systems and methods for interpretation of an outcome of the machine learning model.

An aspect of some embodiments of the present invention relates to systems, methods, an apparatus, and/or code instructions for an add-on to a machine learning (ML) model that computes relative contributions for multiple features in generating a target outcome of the ML model in response to being fed an input of the multiple features. The add-on may be ML model agnostic. The relative contribution of each feature may be represented by a contribution coefficient associated with that feature. The features may include a large number of features, for example, at least 100, or 250, or 500, or 1000, or large number of features, where standard machine learning interpretability approaches that evaluate every single combination by feeding that combination into the ML model are non-practical since a standard computing device cannot compute the relative contributions in a reasonable amount of processing time. At least some of the features are correlated to one another (e.g., covariance value above a threshold), for example, extracted from common data elements. An initial value is estimated (i.e., computed) for each contribution coefficient of each feature. The features are analyzed to identify a most contributing feature with highest contribution coefficient. Other features that are non-independent to the certain feature are identified. The initial value (e.g., current value during iterations) of the respective contribution coefficient of each of the other features and the initial value (e.g., current value during iterations) of the most contributing feature are adjusted according to the highest contribution coefficient according to a covariance with the most contributing feature. The process is iterated, by re-analyzing the features (excluding the previously identified most contributing feature) to find a subsequent most contributing feature with highest contribution coefficient, and re-adjusting the (current value of the) contribution coefficients of the other features according to a covariance with the subsequent most contributing feature. The process is iterated until a stop condition is met, for example, no subsequent most contributing features remain. The respective contribution coefficient of each feature that resulted in the outcome of the ML model is provided, for example, presented on a display, optionally within a graphical user interface (GUI). Actions may be taken, for example, instructions may be generated for adapting one or more of the most significant features that contribute to the outcome, to reduce the outcome below a threshold and/or change the outcome.

Optionally, the features are grouped into clusters of mutually exclusive and/or exhaustive clusters of features. The process may be implemented for the clusters, rather than and/or in addition to individual features, for computing the contribution coefficient per cluster.

At least some implementations of the systems, methods, apparatus, and/or code instructions described herein address the technical problem of computing the relative contribution of each one of multiple different features to an outcome of a machine learning mode generated in response to being fed the multiple different features as input. For example, when an ML model is fed an input to obtain an outcome, and an explanation for the reason for the outcome of the ML model is desired. For example, where an ML model that receives an input of standard blood tests results outputs an outcome indicating high likelihood of a tumor, to help convince a physician that a patient is indeed in high risk of harboring a malignant tumor, and thus requires a screening or diagnostic procedure, by indicating that a certain blood test which is known to the physician to be linked to cancer is a high contributor to the outcome of the ML model. In another example, where an ML Model that receives multiple patient parameters outputs an outcome indicating high likelihood of being admitted to hospital within a short period of time, explaining why the patient is in high risk of being admitted to the hospital within the short period, and guiding the steps that can be taken to prevent the admission, by identifying the most contributing patient parameters which may be addressed to prevent the admission. In another example, where the ML model generates an outcome of a prediction of likelihood of a system failure in response to an input of a large set of measurements to predict system malfunction, an explanation as to why such malfunction is predicted, i.e., computing the relative contribution of the measurements, which may enable reducing risk of system failure by addressing the most significant causes of the measurements. In such environments, many features are correlated and grouping (i.e., clustering) of features is often necessary, posing a technical challenge for computing the relative contribution of the correlated and/or grouped (i.e., clustered) features to the outcome of the ML model in response to an input of the features. In another application, computing the relative contribution of the features may be helpful in the model development stage, in understanding the model's behavior and exposing biases.

ML models often employ complex feature generation and/or classification/prediction methods, employing non-trivial transformation on raw data to generate constant-size feature vectors, and/or further high-complexity functions (e.g. multilayer perceptron or ensemble of classification and regression trees) to generate the model's prediction(s) from these vectors. As such, the number of features may be very large, limiting the ability of standard approaches to compute the relative contribution for each of the features. For example, features vectors may include over 10, 100, 256, 500, 750, 1000, 1024 features, or other intermediate or larger numbers. At least some implementations of the systems, methods, apparatus, and/or code instructions described herein improve the field of ML models, in particular, the field of interpreting outcomes of ML models, by providing an approach for computing the relative contribution of each one of multiple different features to an outcome of a machine learning model generated in response to being fed the multiple different features as input. The contribution of each of the different features to the outcome provides an approach for interpreting the outcome of the ML model.

At least some implementations of the systems, methods, apparatus, and/or code instructions described herein improve the experience of a user interacting with a ML model, by providing the user with a computed relative contribution of each one of multiple different features to an outcome of a machine learning model generated in response to being fed the multiple different features as input. The resulting obscurity (e.g., ‘black-box’ character) of the process is challenging to the applicability of modern ML models, particularly but not necessarily in the medical field in several aspects. For example:
1. Physicians and other users are reluctant to make decisions without understanding the underlying reasoning
2. Regulatory approval may depend on the ability to explain decision
3. It is difficult to make sure that black-box models do not identify spurious pattern that result from biases in the cohorts used for the models' derivation (and validation).
4. Fairness and unbiased performance of the model across different populations is difficult to ascertain for these models.

The improved experience of the user, provided by at least some implementations that compute the relative contribution of feature(s) to the outcome generated by the ML model, helps the user make decisions based on the outcome of the ML model. For example, at least some implementations described herein are used to answer a ‘but-why’ question per single predictions—‘Why does the ML model give a specific score for a specific input?’—Thus making a step forward for example, for items (1) and (2) listed above. Applying at least some implementations described herein on cohorts, allowing an inspector to understand the ML model's predictions (i.e., outcome) as function of different input variables can also make the users (and developers) of the model gain more confidence with regard to points (3) and (4) described above.

Standard approaches, for example based on Shapley values, to computing the contribution of different features to an outcome are designed for simple linear classifiers, for example, regression functions, and/or when a number of features is small. In such cases, Shapley values are computed for each feature by consideration each possible combination of features. Using standard approaches for computing the contribution of each one of multiple features requires large amounts of computational resources (e.g., processor utilization, memory) and/or takes a significant amount of computational time, which is infeasible, for example, for applications running on devices without significant amount of computational resources (e.g., smartphone, laptop), real time applications that provide real time results, and/or server based services where the server simultaneously processes multiple tasks from multiple clients.

It is noted that the Tree-SHAP process is an approach for calculating SHAP values for tree-based models with computational efficiency, for example, as described with reference to Consistent feature attribution for tree ensembles, S. M. Lundberg, S. Lee, arXiv:170.06060, 2017, incorporated herein by reference in its entirety. However, the standard Tree-SHAP process computes the SHAP values for single (i.e., individual features). In contrast, at least some implementations of the systems, methods, apparatus, and/or code instructions described herein compute contribution coefficients per cluster of multiple features, rather than for single features, using an adaptation of the Tree-SHAP process. The adapted Tree-SHAP approach for computing contribution coefficients per cluster of multiple features is described below.

The technical problem may relate to computing the relative contribution of each one of multiple different features to the outcome of the ML model, where at least some of the features are correlated with one another, and/or where at least some of the features are generated from the same signal where the contribution is computed for the signal. Standard approaches, for example, SHAP (Shapley Additive exPlanations) and LIME (Local interpretable model-agnostic explanations), are limited in their ability to handle correlated features properly. Moreover, the SHAP implementation of Shapley values is not model-agnostic.

At least some implementations of the systems, methods, apparatus, and/or code instructions described herein provide a solution to the above mentioned technical problem, and/or improve the technical field of interpretability of ML models, by providing one or more of the following, which are not provided by standard approaches:
An approach designed to compute the relative contribution of features that are highly co-dependent.
An approach that is model-agnostic.
An approach that is designed to work on clusters of features, where the clusters are mutually exclusive and/or exhaustive. Contribution to the outcome of the ML model may be computed for the cluster of feature as a whole, rather than and/or in addition to, single features.

At least some implementations of the systems, methods, apparatus, and/or code instructions described herein address the above mentioned technical problems, and/or improve the above mentioned fields, by one of more of: grouping features into clusters, where the contribution coefficient is assigned to the cluster as a whole rather than and/or in addition to individual features; using covariance and/or mutual information between features that are not independent, where the contribution coefficient of a certain feature is used to increase the coefficient of other feature(s) and the contribution coefficient(s) of the other feature(s) are used to increase the contribution coefficient of the certain feature; and an iterative process, where after identifying the most significant contributing feature (or cluster), coefficients of other coefficients are computed based on the identified most significant contributing feature is iterated.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

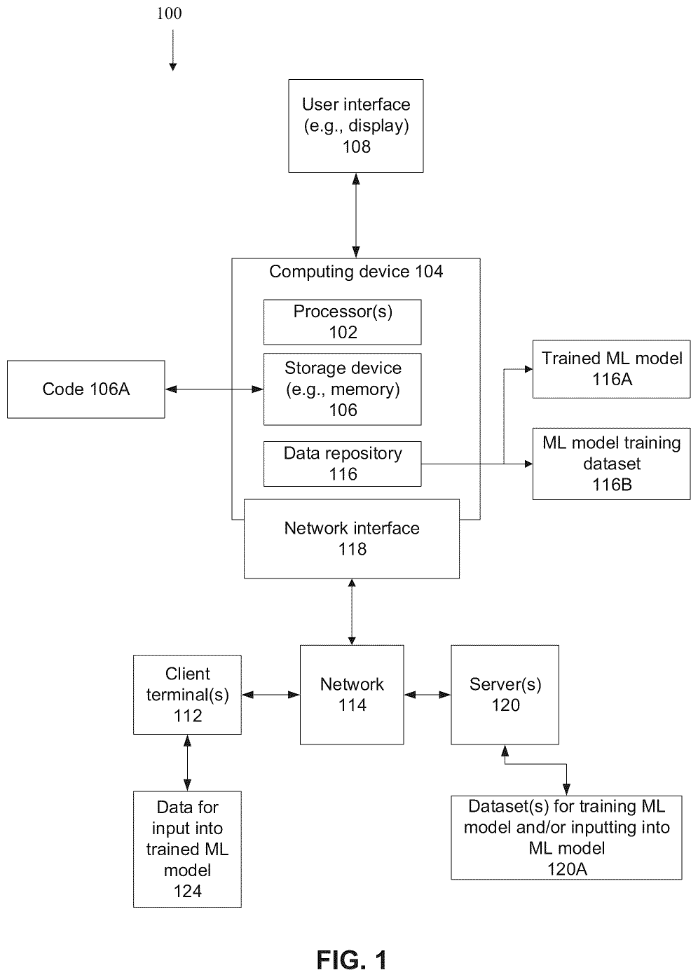

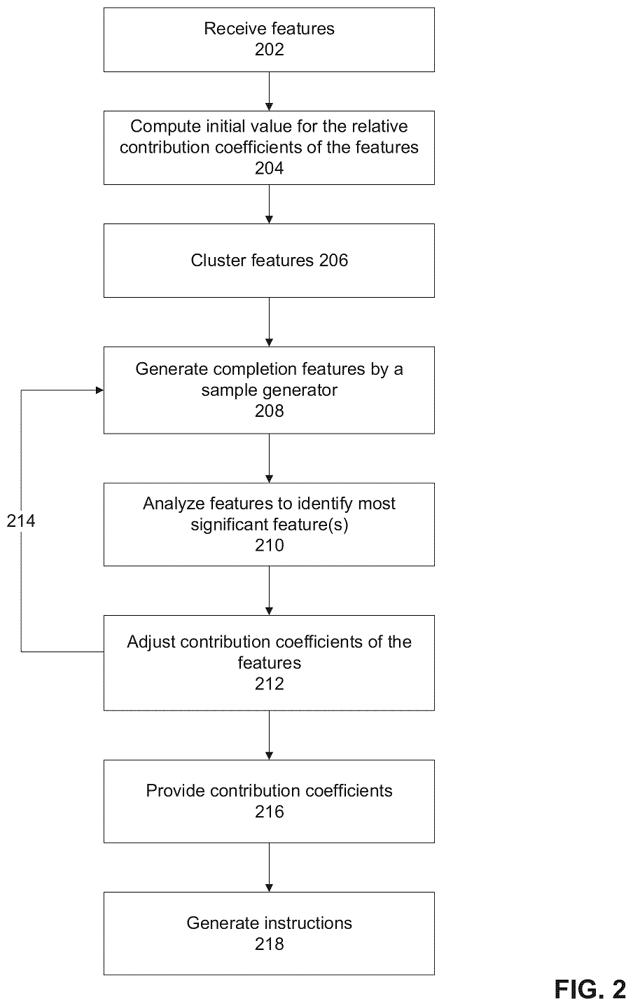

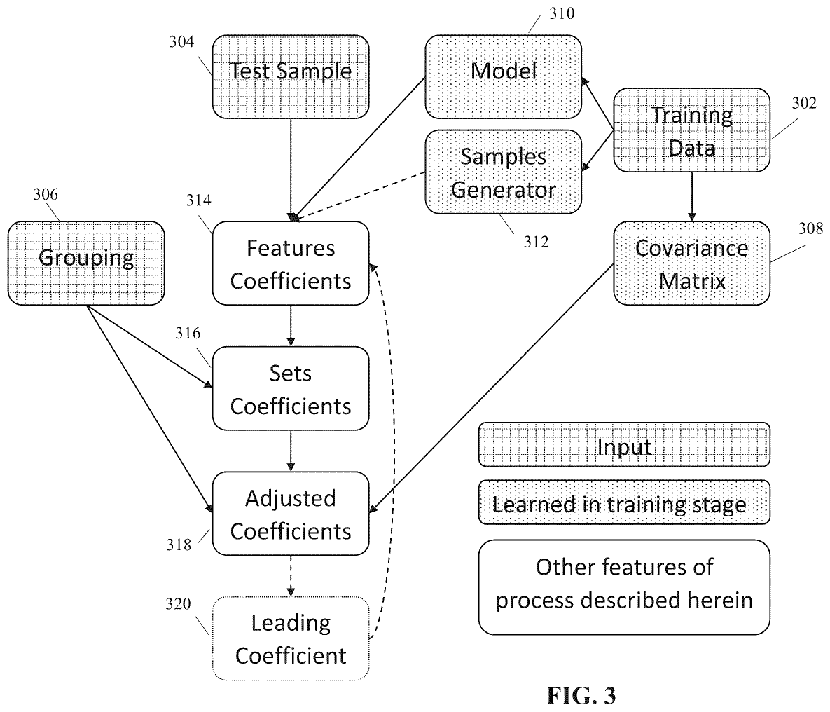

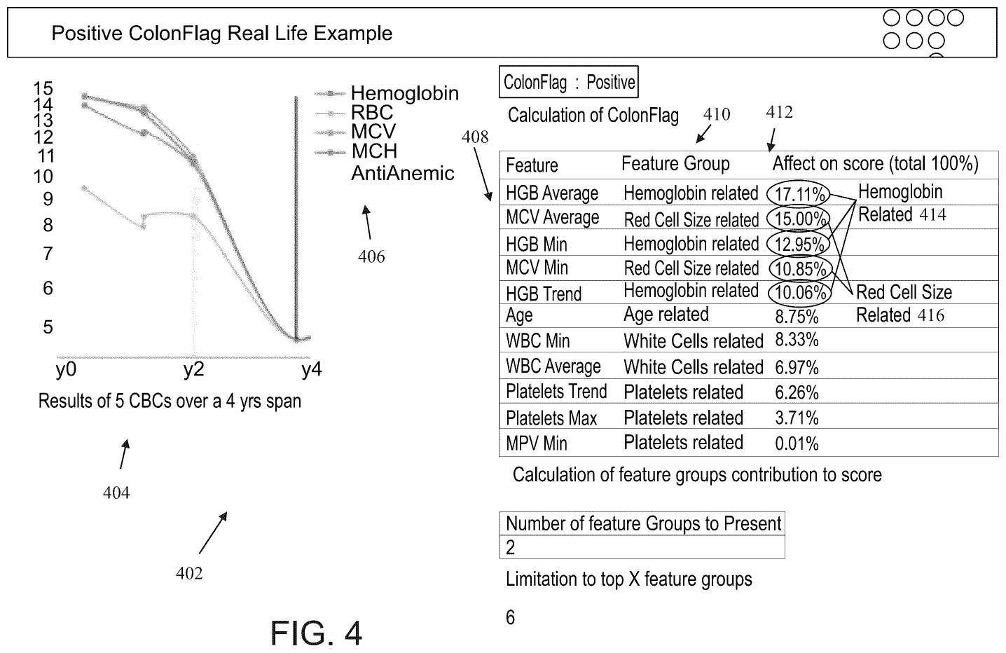

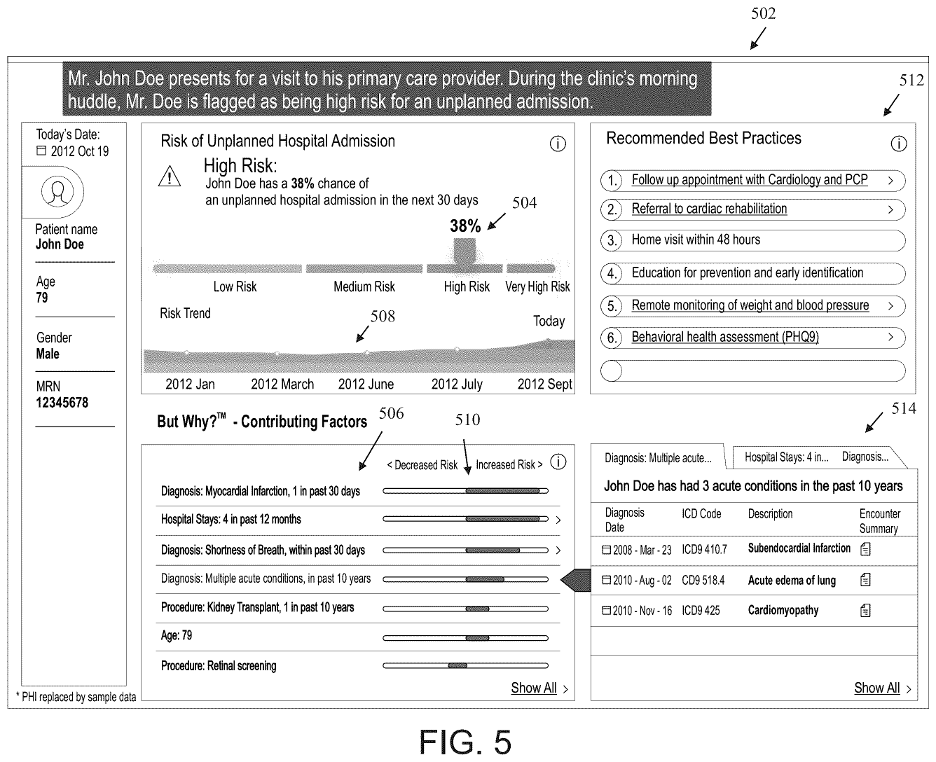

Reference is now made to FIG. 1, which is a block diagram of components of a system 100 that includes an add-on to a ML model for interpreting outcomes of the ML model based on features inputted into the ML model, in accordance with some embodiments of the present invention. Reference is also made to FIG. 2, which is a flowchart of a method for interpreting outcomes of the ML model based on features inputted into the ML model, in accordance with some embodiments of the present invention. Reference is now made to FIG. 3, which is a dataflow diagram of an exemplary dataflow for computing respective contribution coefficients of features inputted into a ML model for generating an outcome, in accordance with some embodiments of the present invention. Reference is also made to FIG. 4, which is an exemplary GUI presenting relative contribution coefficients of features, in accordance with some embodiments of the present invention. Reference is also made to FIG. 5, which is another exemplary GUI presenting relative contribution coefficients of features, in accordance with some embodiments of the present invention.

System 100 may implement the acts of the method described with reference to FIG. 2-5, by processor(s) 102 of a computing device 104 executing code instructions 106A stored in a storage device 106 (also referred to as a memory and/or program store).

The add-on component to the ML model described herein may be implemented, for example, as code 106A stored in memory 106 and executable by processor(s) 102, a hardware card and/or chip that is plugged into an existing device (e.g., server, computing device), and/or a remotely connected device (e.g., server) running code 106A and/or that includes the hardware that executes the features of the method described with FIG. 2, that interfaces with another server running the ML model.

Computing device 104 may be implemented as, for example, a client terminal, a server, a computing cloud, a virtual server, a virtual machine, a mobile device, a desktop computer, a thin client, a Smartphone, a Tablet computer, a laptop computer, a wearable computer, glasses computer, and a watch computer.

Multiple architectures of system 100 based on computing device 104 may be implemented, for example, one or combination of:

In an exemplary implementation, computing device 104 storing code 106A, may be implemented as one or more servers (e.g., network server, web server, a computing cloud, a virtual server) that provides centralized services (e.g., one or more of the acts described with reference to FIG. 2) to one or more client terminals 112, providing software services accessible using a software interface (e.g., application programming interface (API), software development kit (SDK)), providing an application for local download to the client terminal(s) 112, and/or providing functions using a remote access session to the client terminals 112, such as through a web browser. In such implementation, each respective client terminal 112 provides data 124 (e.g., raw data, features which may be extracted from the raw data) for input into trained ML model 116A running on computing device 104, and receives an indication of relative contribution of features and/or of the raw data to the outcome from computing device 104. Computing device 104 may provide the outcome generated by the ML model 116A to the respective client terminal 112.

In another exemplary implementation, computing device 104 storing code 106A, may be implemented as one or more servers (e.g., network server, web server, a computing cloud, a virtual server) that provides centralized services (e.g., one or more of the acts described with reference to FIG. 2) to one or more other servers 120, for example, via the software interface (API and/or SDK), application for download, functions using the remote access session, and the like. Each server 120 may provide centralized ML model services, for example, to client terminals 112. In such implementation, each respective client terminal 112 provides data 124 to server 120 for input into trained ML model 116A which may be running on server 120. Server 120 may generate the outcome of trained ML model 116A is response to input 124. Server 120 may communicate with computing device 104, to receive the interpretation for the outcome of trained ML mode in response to input 124. Server 120 may provide the outcome of the ML model and the corresponding interpretation to respective client terminals 112.

In yet another implementation, computing device 102 may include locally stored code 106A and/or trained ML model 116A, for example, as a customized ML model 116A that may be locally trained on locally generated data, and/or trained on data obtained from example, from dataset(s) 120A on a remote server(s) 120, for example, electronic health record (EHR) servers), picture archiving servers (PACS server), and/or an electrical/mechanical/computer system, as described herein. Computing device 102 may be, for example, a smartphone, a laptop, a radiology server, a PACS server, and an EHR server. Users using computing device 102 provide data 124 (e.g., select the data using a user interface such as a graphical user interface (GUI)) and/or data 124 is automatically obtained (e.g., extracted from the EHR of a patient in response to new test results). The outcome of the ML model and corresponding interpretations are automatically generated and provided, for example, stored in the EHR of the user and/or presented on a display.

Processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include multiple processors (homogenous or heterogeneous) arranged for parallel processing, as clusters and/or as one or more multi core processing devices. Processor(s) 102 may be arranged as a distributed processing architecture, for example, in a computing cloud, and/or using multiple computing devices. Processor(s) 102 may include a single processor, where optionally, the single processor may be virtualized into multiple virtual processors for parallel processing.

Data storage device 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 106 stores code 106A that implements one or more features and/or acts of the method described with reference to FIG. 2 when executed by processor(s) 102.

Computing device 104 may include a data repository 116 for storing data, for example, storing one or more of a trained ML model 116A that generates an outcome in response to input 124 for which an interpretation is computed as described herein, and/or training dataset 116B used to train an ML model to generate trained ML model 116A, as described herein. Data repository 116 may be implemented as, for example, a memory, a local hard-drive, virtual storage, a removable storage unit, an optical disk, a storage device, and/or as a remote server and/or computing cloud (e.g., accessed using a network connection).

Computing device 104 may include a network interface 118 for connecting to network 114, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 114 may be implemented as, for example, the internet, a local area network, a virtual private network, a wireless network, a cellular network, a local bus, a point to point link (e.g., wired), and/or combinations of the aforementioned.

Computing device 104 may connect using network 114 (or another communication channel, such as through a direct link (e.g., cable, wireless) and/or indirect link (e.g., via an intermediary computing unit such as a server, and/or via a storage device) with client terminal(s) 112 and/or server(s) 120 and/or other computing devices, as described herein.

Computing device 104 and/or client terminal(s) 112 include and/or are in communication with one or more physical user interfaces 108 that include a mechanism for a user to enter data (e.g., provide and/or select data 124 for input into trained ML model 116A) and/or view the computed interpretation(s) for the outcome of ML model 116A, optionally within a GUI. Exemplary user interfaces 108 include, for example, one or more of, a touchscreen, a display, a keyboard, a mouse, and voice activated software using speakers and microphone.

Referring now back to FIG. 1, at 202, features (which are fed into the ML model) and/or a target outcome of the ML model generated in response to an input of the features, and/or the ML model are received.

The ML model may be, for example, one or more classifiers, neural networks of various architectures (e.g., fully connected, deep, encoder-decoder), support vector machines (SVM), logistic regression, k-nearest neighbor, decision trees, boosting, random forest, and the like. Machine learning models may be trained using supervised approaches and/or unsupervised approaches.

Optionally, subsets of two or more features are correlated to each other, for example, having a covariance value above a threshold, for example, above about 0.5, or 0.6, or 0.7, or other values.

The features, optionally the correlated features, may be extracted from a common set of raw data, for example, an aggregation of a set of values such as a time sequence of data elements with different time stamps, for example, an average, a mean, a mode, a highest value, a lowest value, and an indication of a trend. In another example, feature may be computed as mathematical functions applied to a combination of two or more different raw data elements, for example, transformations, multiplications, and/or other combinations.

The number of features, optionally extracted from the raw data may be large, for example, at least 50, or 100, or 256, or 500, or 750, or 1024, or greater.

Features may be, for example, extracted from blood test results, for example, Red blood test results (e.g., red blood cells (RBC), red cell distribution width (RDW), blood tests hemoglobin (MCH), mean cell volume (MCV), mean corpuscular hemoglobin concentration (MCHC), Hematocrit, and Hemoglobin), while blood test results (e.g., neutrophils count, basophils count, eosinophils count, lymphocytes count, monocytes count, WBC count, neutrophils percentage, basophils percentage, eosinophils percentage, lymphocytes percentage, and monocytes percentage), platelet blood test results (e.g., of platelets count, and mean platelet volume (MPV)), biochemistry blood test results (Erythrocyte Sedimentation Rate (ESR), Glucose, Urea, Blood Urea Nitrogen (BUN), Creatinine, Sodium, Potassium, Chloride, Calcium, Phosphorus, Uric Acid, Bilirubin Total, Lactate Dehydrogenase (LDH), glutamic oxaloacetic transaminase (GOT), Serum glutamic oxaloacetic transaminase (SGOT), and Glutamate Oxaloacetate, Aspartate transaminase (AST), Aspartate Aminotransferase, glutamate pirovate transaminase (GPT) Serum glutamate pirovate transaminase (SGPT), alanine aminotransferase (ALT), Alkaline Phosphatase (Alk Phos/ALP), gamma glutamyl transpeptidase (GGT), Albumin, CK (Creatine Kinase), Iron, HbA1, B12, Vitamin D, G-6-PD, Lithium, Folic Acid, CRP (C reactive protein), low-density lipoprotein (LDL), high-density lipoprotein (HDL), Triglycerides, Total cholesterol, Amylase, PT (Prothrombin Time), Partial Thromboplastin Time (PTT), Activated Partial Thromboplastin Time (APPT), (International Normalized Ratio (INR), Fibrinogen, Cytidine triphosphate (CPT), Ferritin, glomerular filtration rate (GFR), transferrin, Total iron-binding capacity (TIBC), Unsaturated iron-binding capacity (UIBC)), and/or patient parameters (e.g., age, smoking history, medical history), obtained for example, from an electronic medical record of a patient.

In another example, features may be measurements of different components of an electrical/mechanical/computer system, for example, for a car, measurements of speed, tire pressure, transmission, engine RPM, and the like. The outcome may be an indication of likelihood of failure of the car. In another example, the system is a computer network, and the features are measurements of components of the network, for example, bandwidth utilization, router processor utilization, number of end points, and the like. The outcome may be an indication of network failure.

Contribution coefficients may be computed per feature, as described herein. Contribution coefficients may represent the relative contribution of the respective feature to the outcome of the ML model. For example, the contribution coefficients are percentages, with the sum of the contribution coefficients of all features equaling 1 or 100%. For example, for 3 features, the following represent an example of the contribution coefficients: feature-1=10%, feature-2=60%, feature-3=30%. Feature-2 has the most impact on the outcome.

Features may be stored in a feature vector.

At 204, a respective initial value is computed for each respective contribution coefficient associated with each feature. The initial values of the contribution coefficients are iteratively adjusted (e.g., as described with reference to 212 and 214) to obtain the final value for the contribution coefficients which is provided, as described herein.

The initial values of the contribution coefficients may be computed using different approaches. Some exemplary approaches are now described.

At least some embodiments described herein are based on an adaptation of Local Interpretable Model-agnostic Explanations (LIME), for example, as described with reference to Why should I trust you? Explaining the predictions of any classifier, M. T. Ribeiro et al. arXiv: 1602.04938, 2016 and/or Shapley values also referred to as SHAP (SHapley Additive exPlanation) values, for example, as described with reference to A value for n-person games, L. S. Shapley, Contributions to the Theory of Games 2.28, 1953, pp. 307-317. LIME and Shapely values may be part of a unified framework, for example, as described with reference to A unified Approach to interpreting model predictions, S. M. Lundberg, S. Lee, arXiv: 1705.07874, 2017, all of which are incorporated herein by reference in their entirety. As described herein, the standard Shapley-LIME and/or Shapely approaches, which are based on considering every single subcombination of features and computation of expected outcomes by the ML model for each subcombination of features, are computationally infeasible, since cannot be practically implemented in a reasonable amount of processing time and/or using a reasonable amount of computational resources for a large number of features and/or for features that are correlated with one another. The adaptations described herein are designed for processing large number of features and/or features that are correlated with one another in a reasonable amount of processing time and/or using a reasonable amount of computational resources.

Rather than using the SHAP and/or LIME approaches to compute the final values of the contribution coefficients (which is computationally infeasible as discussed above), the SHAP and/or LIME approaches may be used to compute the initial values of the contribution coefficients, which are then iteratively adapted as described herein.

SHAP values (ϕᵢ) are given by Equation (1):

$${ϕ}_{i} = {\sum }_{S ⊆ F \backslash \{ i \}} \frac{\vert S \vert ! ( M - \vert S \vert - 1 ) !}{M !} [ {f}_{x} ( S ⋃ \{ i \} ) - {f}_{x} ( S ) ]$$

Where F denotes the set of all features, M=|F|, f(x) denotes the ML model outcome (also referred to as prediction) that is being interpreted, and fₓ(S)≡E[f(z)|zₛ=xₛ] denotes the expected value of f given the subset of features in S is set to xₛ.

LIME, on the other hand, uses a local linear model to explain the outcome of the ML model. A linear combination is defined as:

g(\vec{y})=ϕ₀+Σϕᵢyᵢ

and the following weighted (penalized) least square loss function is minimized:

L(f,g,π)=Σ[f(y)−g(y)]²πₓ(y)+Ω(g)

Where πₓ (Z) denotes a kernel function, concentrated around the neighborhood of x.

In order to incorporate LIME into the SHAP framework (Shapley-LIME), binary features are defined per each subset S as follows:

$${z}_{i} = \{ \begin{matrix}1 & if i ∈ S \\ 0 & if i ∉ S\end{matrix}$$

A linear combination of these features that minimizes the loss function is identified by Equation (2):

L(f,g,π)=Σ[f(hₓ⁻¹(z))−g(z)]²πₓ(z)

Where f(hₓ⁻¹(z))≡fₓ(S), the kernel is denoted as

$${π}_{x} ( z ) = ( M - 1 ) / ( ( \begin{matrix}M \\ \vert z \vert\end{matrix} ) \vert z \vert ( M - \vert z \vert ) ) ,$$

where |z| denotes the number of non-zero elements in z, and the sum goes over all subset S.

Alternatively or additionally, the initial values for the contribution coefficients may be computed using artificial features outputted by the sample generator, as described with reference to 208. In such implementations, 204 may be implemented before, in parallel to, and/or combined with 208. The values generated by the sample generator (e.g., as in 208) may be used for iterative adjustment of the values of the coefficients (e.g., as in 212 and/or 214), as described herein.

At 206, features may be grouped into sets, also referred to herein as clustered into clusters. The clusters may include mutually exclusive and/or exhaustive sets of features. All features may be included within a union of the set of clusters. For example, features that are correlated to one another above a threshold are included in a common cluster, while other independent features that are below the threshold are excluded from the cluster (and included in another cluster).

Contribution coefficients may be computed per cluster, for example, using a Tree-SHAP approach, as described herein. Each cluster may include multiple (i.e., two or more features).

In terms of mathematical notation, features are clustered into clusters and contribution coefficients denoted ϕ_{G}_{ᵢ} are assigned to mutually exclusive and exhaustive clusters of features denoted Gᵢ⊆F such that Gᵢ∩Gⱼ=Ø and ∪Gᵢ=F.

Optionally, contribution coefficients (also referred to herein as set contribution coefficients) are computed per cluster of features based on an adaptation of the Tree-SHAP process. Briefly, the Tree-SHAP process is based on traversing all nodes in a feature decision tree and updating contribution coefficients denoted ϕᵢ according to nodes where the local decision is based on the respective feature denoted i. The number of samples going through each split at each respective node is maintained by the tree to correctly estimate fₓ(S). Computing contribution coefficients for clusters of multiple features may be obtained by considering all nodes where the respective location decision is based on a feature denoted i∈G as corresponding to G.

As used herein, the term set contribution coefficients refers to the contribution coefficient(s) computed for a cluster (e.g., per cluster) of features.

Optionally, the feature decision tree is computed based on the Tree-SHAP process when other features described herein based on the Tree-SHAP process are implemented. The feature decision tree may be used for independent features, in addition to and/or alternatively to clustering and/or for clusters. The feature decision tree includes multiple interconnected nodes originating from a common root. Each respective node represents at least one feature indicating a decision at the respective node based on the respective feature. A path along edges connecting nodes extending from the common root to a respective leaf represent an increasing number of features and a respective combination of decisions that arrive at a certain predicted outcome of the ML model represented by the respective leaf and nodes along the path.

At 208, completion features (also referred to herein as artificial features) may be generated by a sample generator.

The completion features may be artificially computed features that are designed to correspond to actual features which may be extracted from actual raw data, where the actual features are fed into the ML model. The completion features may be generated as an outcome of the sample generator that is fed as input, a selected subset of the features.

The completion features may be generated according to a joint distribution of the selected subset of features.

A complete feature vector may be created, that includes the selected subset of features (used to create the completion features) and the completion features (created based on the subset of features).

In some embodiments, an exemplary sample generator includes, for example, a Generative Adversary Networks (GAN), for example, as described with reference to Generative Adversarial Networks, I. Goodfellow et al. arXiv:1406.2661, 2014, incorporated herein by reference in its entirety. The GAN uses a neural network as the sample generate for generating features that a competing neural network (NN) fails to distinguish from true features. For using the subset of known features, the generative NN also gets, as input, a mask indicating which of the features are known, for example, as described with reference to GAIN: Missing data imputation using generative adversarial networks, J. Yoon, arXiv:1806.02920, 2018, incorporated herein by reference in its entirety.

In some embodiments, an exemplary sample generator is based on, for example, Gibbs Sampling where iterative sampling from the marginal distribution denoted p(xᵢ|x₁ . . . xᵢ₋₁, xᵢ₊₁ . . . xₙ) converges to sampling from the joint distribution. Known features are handled by skipping them in the Gibbs sampling process. Sampling from the marginal distribution is performed by building predictive models for xᵢ from x₁ . . . xᵢ₋₁, xᵢ₊₁ . . . xₙ. Two exemplary approaches for building such models that enable sampling include:
Random Forests: In each leaf of each tree of the predictor RF (x₁ . . . xᵢ₋₁, xᵢ₊₁ . . . xₙ)→xᵢ, keep all values {xᵢ} of the relevant samples, and randomly select from this set in the sampling stage.
Model-agnostic approach: split the range of values of xᵢ into N bins Bₙ, n=1 . . . N, and build N independent classification models Mᵢₙ(x₁ . . . xᵢ₋₁, xᵢ₊₁ . . . xₙ)→I(xᵢ∈Bₙ). Use pᵢₙ=softmaxₙ(Mᵢₙ) to select xᵢ in the sampling stage.

The complete feature vector may be inputted into the ML model for obtaining a complete outcome. The complete outcome may be used for computing of the initial set of contribution coefficients, which are then adjusted, as described herein. The complete feature vector may be used in the iterative process described with reference to 214 of FIG. 2. The complete feature vector may be used in the following exemplary process, by iterating the following steps a predefined number of times and/or until a stop condition is met:
A subset of the features is selected, mathematically denoted S⊆F(mask). The subset of features represents an incomplete set of a feature vector, as described herein. In each iteration another subset of features is selected. For the case of clusters, the selection of the subset of features is mathematically represented as Select a subset of features sets H⊆{Gᵢ}, and define S=∪H.
The subset of features is inputted into the sample generator for obtaining an outcome of artificial completion features. A complete feature vector that includes the subset of features and the outcome of artificial completion features is generated. In terms of mathematical representation, generate a feature vector \vec{x} by applying the sample-generator on xₛ. The same approach is used for the case of clusters.
The complete feature vector is inputted into the ML model for obtaining a complete outcome, mathematically represented as Calculate f(\vec{x}). The same approach is used for the case of clusters.
The initial set of contribution coefficients may be computed and/or updated for the features of the subset using the corresponding complete outcome, for example, based on Equation (1) for the SHAP values. In terms of mathematical notation, update ϕᵢ for all i∈S. For the case of clusters, the initial set of contribution coefficients is computed and/or updated per cluster, mathematically represented as Update ϕ_{H}_{ᵢ} for all Hᵢ∈H.

Another exemplary process for computing the initial set of contribution coefficients, which are further adjusted as described herein, include solving the minimization problem using Equation (2) on a randomly generated matrix of M columns (the number of features) and N rows. Each line in the matrix corresponds to a random mask denoted S, corresponding to the selected subset of features. Non-selected features are denoted as incomplete features. The corresponding row is the binary indicator vector denoted \vec{z}, and the label element denoted f(hₓ⁻¹(z)) is generated by applying the sample-generator on the selected subset of features denoted xₛ to compute artificial completion features, storing the artificial completion features at the location of the incomplete features, generating a feature vector including the selected subset and the artificial completion features, inputting the feature vector into the ML model, and obtaining a complete outcome from the ML model fed the feature vector. A suitable method for solving linear least-square may be used to generate an estimate of the initial value for the contribution coefficients denoted ϕᵢ from the matrix. The initial values of the contribution coefficients are adjusted, as described herein.

Optionally, for the case of clusters, the columns in the matrix are changed from representing single features to representing clusters of features (thus having |{Gᵢ}| columns). A row \vec{z}′corresponds to a mask S=∪_{i|z}_{ᵢ}_{′=1}Gᵢ.

At 210, the features may be analyzed to identify a certain feature with highest contribution coefficient, sometimes referred to herein as most significant feature. The certain features may be identified according to an associated contribution coefficient with highest absolute value. It is noted that in some implementations (e.g., during a first iteration), the highest contribution coefficient may be identified after a first adjustment of the contribution coefficients, for example, 210 may be implemented after 212 and before the iterations of 214.

Optionally, the certain feature with highest contribution coefficient is identified per set of features that are correlated to one another, i.e., excluding independent features that are not correlated to the set of features, for example per cluster.

Alternatively or additionally, the cluster with highest contribution coefficient is identified (sometime referred to herein as most significant cluster), where the contribution coefficient is assigned to the cluster as a whole.

At 212, contribution coefficients of the feature(s) are adjusted (for example, sometimes referred to herein as covariance and/or mutual information fixing). The adjusted may be made to the initially computed contribution coefficients, and/or to the previously adjusted contribution coefficients.

For two or more features that are not independent (e.g., per cluster) the contribution coefficient of each respective feature is used to increase the contribution coefficient of the other features, and the contribution coefficient of the other feature(s) is used to increase the contribution coefficient of the respective feature. The adjustment of the respective contribution coefficient of each feature may be performed according to a covariance with the contribution coefficient of the other feature.

Optionally, the adjustment is relative to the most significant feature with highest contribution coefficient.

Optionally, the adjustment is relative to the certain cluster with highest contribution coefficient.

For the case of feature decision trees based on the Tree-SHAP approach, each respective contribution coefficient is updated for respective features represented by respective nodes of the feature decision tree.

When the contribution coefficients are computed (e.g., based on different approaches, for example, as described herein), the respective contribution coefficient of each respective feature is adjusted (e.g., covariance and/or mutual-information fixing is performed) by multiplying a coefficient vector by a covariance matrix. The coefficient vector may include the respective contribution coefficients of the features. The covariance matrix may be computed from a training dataset storing training features labelled with a training outcome used to train the ML model.

In terms of mathematical notation, the contribution coefficients of the feature(s) may be adjusted by defining a covariance (or mutual information) matrix denoted C, for example, an n×n matrix, where n denotes the number of features, and C u denotes the absolute value of the covariance between features i and j, and Cᵢᵢ=1. Given an initial vector of coefficients denoted JD, the adjusted vector is denoted as f1=C f0(i.e., matrix-vector multiplication).

For the case of clusters of features, computing the contribution coefficients is more challenging. In the case of clusters, the contribution coefficients are computed both for features (ϕᵢ) and sets (ϕ_{G}) and a set covariance matrix is computed according to the following mathematical relationship:

$${\hat{C}}_{GH} = \frac{{\sum }_{i ∈ G , j ∈ H} {ϕ}_{i} {ϕ}_{j} {C}_{ij}}{{\sum }_{i ∈ G , j ∈ H} {ϕ}_{i} {ϕ}_{j}}$$

The sets coefficient vector is multiplied with the sets covariance matrix to obtain the contribution coefficients for the respective cluster of features.

The approach described herein may be implemented for embodiments that use the sample generator.

At 214, features 208-212 are iterated until a stop condition is met, for example, no remaining most significant features remain and/or once the computed contribution coefficient(s) computed for each of the features has stabilized to a stable value. It is noted that feature 208 is iterated in embodiments using the sample generator.

During the iterations, a conditional process may be applied, for example, by calculating the coefficients given the values of the already selected most significant features, for example, as follows:

At each subsequent iteration, the most significant feature identified in the previous iteration may be excluded. The remaining features (excluding the previously identified most significant feature) may be analyzed to identify the current most significant feature. The contribution coefficients of the remaining features may be re-adjusted (from their values in the previous round) relative to the current most significant feature. The iterations may be continued, each time excluding the most significant feature, until a single feature remains, or a set of independent (e.g., covariance value below the threshold) features remain.

Alternatively, at each subsequent iteration, the features are re-analyzed to identify the current most significant feature (without excluding the previously identified most significant feature). The contribution coefficients may be re-adjusted (From their values in the previous round) relative to the contribution coefficients of other features. The iterations may be continued until a stabilized state is achieved, where the same feature is identified as most contributing over additional iterations, and the contribution coefficients are not re-adjusted since their value remains stable over additional iterations.

For the case based on the Tree-SHAP approach, the iteration may be performed by applying a condition that when a predefined number of most significant features (or sets) with highest contribution coefficients are computed, a new feature decision tree is generated. For each respective node with a respective decision made on a respective computed highest contribution coefficient, the respective node is removed and an edge going into the node is joined to an edge going out of the node corresponding to the respective feature. In this manner, the new feature decision tree becomes increasingly smaller as the number of most significant features (or sets) are identified and removed, until no connected nodes remain, or the remaining nodes are only connected to the root but not to one another.

For embodiments that use the sample generator, for a first predefined number of selected features (directly or through clusters), the masks denoted S fed into the sample generator are selected to include these selected features.

At 216, the contribution coefficients for the features are provided, for example, presented on a display (e.g. within a GUI), stored in a data storage device, forwarded to another computing device (e.g., over a network), and/or provided to another process for further processing.

At 218, instructions may be generated based on the computed contribution coefficients.

Optionally, one or more features with respective contribution coefficient that represents a significant contribution to the outcome are selected. For example, the features with respective contribution coefficient above a threshold are selected, or the top predefined number of features with highest contribution coefficients are selected (e.g., top 3). The selected features may significantly impact the outcome, for example, a change in the selected feature may correspond to a significant change in the outcome, for example, change in classification category (e.g., likelihood of cancer to non-likelihood of cancer) and/or significant change in value of the outcome (e.g., likelihood of cancer change from 80% to 50%). The instruction may be for adjustment of the selected features (increasing and/or decreasing) for triggering a significant change in the outcome, for example, from one classification category to another classification category, and/or a change in value in the outcome above a threshold (e.g., greater than 10%, or 25%, or other value).

For example, when the outcome is an undesired medical condition (e.g., likelihood of cancer, likelihood of heart attack, likelihood of being admitted to hospital), the instructions may be for treating the patient to change the outcome from the undesired medical condition to lack of undesired medical condition, and/or to significantly reduce the risk of the undesired medical condition (e.g., above the threshold), by administering a medication to change (e.g., reduce and/or increase) the value of the identified feature(s). For example, when a certain blood test of the patient is found to indicate the outcome of likelihood of developing cancer, a drug is administered to the patient to reduce the value of the blood test to trigger a change in the outcome to unlikely to develop cancer.

In another example, when the outcome is a prediction of likelihood of failure of an electrical and/or mechanical and/or computer system, and features includes measurements of components of the system, the instructions may be for reducing risk of system failure by improving operation of a component having a measurement that most contributes to likelihood of failure of the system. For example, presenting on a dashboard of a car, a warning that the engine requires an urgent oil change to prevent failure.

The generated instructions may be, for example, a presentation on a display for manual implementation by a user, and/or code for automated execution by a controller.

Referring now back to FIG. 3, blocks 304, 304, and 306 represent input into the ML model and/or into the process for computing the respective contribution coefficients, for example, provided by a user, and/or obtained from a dataset (e.g., file) stored in a memory. Blocks 308, 310, and 312 occur as part of a training stage of the ML model. Blocks 314, 316, 318, and 320 may be implemented, for example, using the method described with reference to FIG. 2. Training data 302 is used to train ML Model 310, provided as input to train samples generator 312 for generating artificial features, and used to compute a covariance matrix 308, as described herein. Features may be extracted from test sample 304 (or test sample 304 represents the features), and an outcome is generated by model 310 in response to an input of test sample 304. Features coefficients 314 are initially computed, based on the features and/or outcome of ML model 310 generated in response to an input of the features, as described herein. Feature coefficients 314 may be initially computed using the artificial features generated by sample generator 312, as described herein. The generation of feature coefficients 314 may be performed, for example, as described with reference to 204 and/or 208 of FIG. 2. Features may be clustered to create groupings 306 (also referred to herein as clusters), for example, as described with reference to 206 of FIG. 2. Sets coefficients 316 (also referred to herein as cluster coefficients, or coefficients of clusters) are computed for grouping 306, for example, as described with reference to 206 and/or 208 of FIG. 2 Adjusted coefficients 318 are created by adjusting the initial value (or previously adjusted value) of the contribution coefficients, optionally using covariance matrix 308, for example, as described with reference to 210 and/or 212 of FIG. 2 Leading coefficients 320, having highest coefficient values, are identified, for example, as described with reference to 210 of FIG. 2. Leading coefficients 320 are used in subsequent iterations of 314, 316, 318, and 320, to arrive at the final values of the contribution coefficients, for example, as described with reference to 214 of FIG. 2.

Referring now back to FIG. 4, a GUI 402 may include a presentation of raw data 404, for example, a plot of multiple results of blood test values obtained over a 4 year span. Blood tests results 406 shows include Hemoglobin, red blood cells (RBC), mean corpuscular volume (MCV), mean cell hemoglobin (MCH), and an indication whether the patient is anemic or anti-anemic. Other blood tests, such as white blood cell (WBC) tests, platelet tests, and patient parameters (e.g., age) may be used as input. Features 408 are extracted from raw data 404, for example, HGB average, MCV average, HGB Min, MCV Min, HGB trend, Age, WBC min, WBC average, Platelets trend, Platelets Max, MPV Min. Features 408 may be clustered to create feature groups 410, for example, hemoglobin related, red cell size related, age related, white blood cell related, and platelets related. The computed relative value of the respective contribution coefficient of each feature 412 may be computed as a percentage, and presented. The sum of the contribution coefficients of all features is 100%. Each cluster may be marked, for example, a hemoglobin related cluster 414 and a red cell size related cluster 416. It is noted that the features extracted from the raw data may be inputted into an ML model that generates an outcome, for example, an indication of risk of colon cancer, referred to herein as ColonFlag.

Referring now back to FIG. 5, a GUI 502 may include a presentation of an outcome 504 of features 506 fed into an ML model. For example, as shown, the outcome is a 38% chance of an unplanned hospital admission in the next 30 days. A risk trend 508 of the values of the outcome computed at different times may be presented, for example, to help detect an increase. Relative values of contribution coefficients 510 are computed for each feature 506, and may be presented as a bar graph. GUI 502 may present one or more recommended best practices 512, indicating actions that may be taken, for example, treatment of the patient, to reduce the relative contribution of the most significant features that lead to the 38% risk in an attempt to reduce the 38% risk by reducing the value of the most significant features. GUI 502 may present raw data 514 used to compute a selected feature, for example, the diagnoses dates, ICD codes, and/or descriptions used to compute the feature of Diagnosis: Multiple acute conditions in the past 10 years.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models will be developed and the scope of the term machine learning model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An add-on component to a system executing a machine learning (ML) model, comprising:
at least one hardware processor executing a code for:
receiving a plurality of features and an outcome of the ML model generated in response to an input of the plurality of features,
wherein at least two of the plurality of features are correlated to each other by a covariance value above a threshold;
computing a respective contribution coefficient denoting an initial value, for each of the plurality of features;
analyzing the plurality of features to identify a certain feature with highest contribution coefficient indicative of a relative contribution of the certain feature to the outcome;
computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature;
iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature; and
providing the respective contribution coefficient for each of the plurality of features.

2. The add-on component of claim 1, further comprising code for:
computing a feature decision tree including a plurality of connected nodes, each respective node denoting a respective at least one feature of the plurality of features indicating a decision at the respective node based on the respective at least one feature, wherein a path along edges connecting nodes extending from a common root to a respective leaf denote an increasing number of features and a respective combination of decisions that arrive at a certain predicted outcome of the ML model represented by the respective leaf and nodes along the path;
wherein the respective contribution coefficient is updated for respective features represented by respective nodes of the feature decision tree.

3. The add-on component of claim 2, wherein the respective contribution coefficient of the respective feature is adjusted according to the covariance with the contribution coefficient of the certain feature, comprises:
multiplying a coefficient vector including a plurality of the respective contribution coefficients of the plurality of features, by a covariance matrix computed from a training dataset storing training features labelled with a training outcome used to train the ML model.

4. The add-on component of claim 2, wherein iterating comprises applying a condition that when a predefined number of certain features with highest contribution coefficients are computed, a new feature decision tree is generated, and wherein for each respective node with a respective decision made on a respective computed highest contribution coefficient, the respective node is removed and an edge going into the node is joined to an edge going out of the node corresponding to the respective feature.

5. The add-on component of claim 1, wherein computing the initial value for the respective contribution coefficients for each of the plurality of features comprises:
in a plurality of iterations:
selecting a respective subset of the plurality of features,
wherein the subset of the plurality of features represent an incomplete set of features of a feature vector,
wherein in each iteration another subset is selected;
generating a plurality of completion features by inputting the subset of the plurality of features into a sample generator that computes artificial completion features;
generating a complete feature vector that includes the subset of the plurality of features and the plurality of completion features;
inputting the complete feature vector into the ML model;
obtaining a complete outcome of the ML model in response to the input of the complete feature vector; and
computing the initial value for each respective contribution coefficient of the features of the subset using the corresponding complete outcome;
wherein the iterations are performed for each respective subset of a plurality of subset of the plurality of features using the respective complete outcome of the ML model.

6. The add-on component of claim 5, wherein the respective contribution coefficient of the respective feature of the respective selected subset of features is adjusted according to the covariance with the contribution coefficient of the certain feature of the respective selected subset, comprises:
multiplying a coefficient vector including a plurality of the respective contribution coefficients of the selected subset, by a covariance matrix computed from a training dataset storing training features labelled with a training outcome used to train the ML model.

7. The add-on component of claim 5, wherein for a first predefined number of selected features, masks fed into the sample generator are selected to include the selected features.

8. The add-on component of claim 1, wherein computing the initial value for the respective contribution coefficients for each of the plurality of features comprises:
generating matrix having a first number of columns corresponding to a number of the plurality of features, and a second number of rows,
for each respective row:
selecting a respective subset of the plurality of features, wherein non-selected features are denoted as incomplete features;
inputting the selected subset of the plurality of features into a sample generator that computes artificial completion features;
storing the artificial completion features at the location of the incomplete features;
wherein each respective row is associated with a binary indicator vector;
generating a feature vector including the selected subset of the plurality of features and the artificial completion features;
inputting the feature vector into the ML model;
obtaining a complete outcome from the ML model fed the feature vector;
computing the initial value of the respective contribution coefficient for each respective feature of each respective row by applying a linear least-square process to the matrix.

9. The add-on component of claim 1, further comprising code for:
clustering the plurality of features into a plurality of clusters, wherein each respective cluster includes a subset of at least two features of the plurality of features, wherein the plurality of clusters are mutually exclusive and exhaustive;
analyzing the plurality of clusters to identify a certain cluster with highest contribution set coefficient indicative of a relative contribution of the certain cluster to the outcome;
computing, for each respective cluster of a subset of the plurality of clusters that are non-independent with respect to the certain feature, a respective set contribution coefficient by adjusting the respective set contribution coefficient of the respective cluster according to a covariance with the set contribution coefficient of the certain feature;
iterating the analyzing and the computing to compute a subsequent certain cluster with highest set contribution coefficient for the remaining plurality of clusters excluding the previous certain cluster, and re-adjusting the respective set contributing coefficient according to a covariance with the set contribution coefficient of the subsequent certain cluster; and
providing the respective set contribution coefficient for each of the plurality of clusters.

10. The add-component of claim 9, wherein computing, for each respective cluster of the subset of the plurality of clusters that are non-independent with respect to the certain feature, the respective set contribution coefficient by considering nodes where a respective location decision is based on a feature denoted i∈G as corresponding to G, in a process comprising traversing nodes in a feature decision tree and updating contribution coefficients denoted ϕᵢ according to nodes where a local decision is based on a respective feature denoted i, wherein a number of samples going through each split at each respective node is maintained by the tree to estimate fₓ(S).

11. The add-on component of claim 10, wherein the respective set contribution coefficient of the respective cluster is adjusted according to the covariance with the set contribution coefficient of the certain cluster, comprises:
multiplying a set coefficient vector including a plurality of the respective set contribution coefficients of the plurality of clusters and a plurality of respective contribution coefficients of the plurality of features, by a set covariance matrix computed from a training dataset storing training features labelled with a training outcome used to train the ML model.

12. The add-on component of claim 9, wherein computing the initial value for the respective contribution coefficients for each of the plurality of features comprises:
in a plurality of iterations:
selecting a respective subset of features from the plurality of clusters;
wherein the subset of features represent an incomplete set of features of a feature vector,
wherein in each iteration another subset is selected;
generating a plurality of completion features by inputting the subset of features into a sample generator that computes artificial completion features;
generating a complete feature vector that includes the subset of features and the plurality of completion features;
inputting the complete feature vector into the ML model;
obtaining a complete outcome of the ML model in response to the input of the complete feature vector; and
computing the initial value for each set of contribution coefficients for the plurality of clusters using the corresponding complete outcome.

13. The add-on component of claim 9, wherein computing the initial value for the respective contribution coefficients for each of the plurality of features comprises:
generating matrix having a first number of columns corresponding to a number of the plurality of clusters, and a second number of rows,
for each respective row:
selecting a respective subset of the plurality of features from the plurality of clusters, wherein non-selected features are denoted as incomplete features;
inputting the selected subset of the plurality of features into a sample generator that computes artificial completion features;
storing the artificial completion features at the location of the incomplete features;
wherein each respective row is associated with a binary indicator vector;
generating a feature vector including the selected subset of the plurality of features and the artificial completion features;
inputting the feature vector into the ML model;
obtaining a complete outcome from the ML model fed the feature vector; and
computing the initial value for the respective contribution coefficient for each respective cluster of each respective row by applying a linear least-square process to the matrix.

14. The add-on component of claim 1, wherein at least two of the plurality of features that are correlated to each other are extracted from a same set of raw data elements.

15. The add-on component of claim 14, wherein the raw data elements include blood tests results selected from a group consisting of: red blood cell test results, white blood cell test results, platelet blood test results.

16. The add-on component of claim 14, wherein extracted comprises aggregating a time sequence of data elements with different time stamps, and/or mathematical functions applied to a combination of two or more different data elements.

17. (canceled)

18. The add-on component of claim 1, wherein the at least two of the plurality of features that are correlated to each other have a covariance value above about 0.7.

19. (canceled)

20. The add-on component of claim 1, further comprising:
identifying at least one of the plurality of features with respective contribution coefficient that trigger a significant change of the outcome when the identified at least one feature is changed;
generating instructions for adjustment of the identified at least one feature for significantly changing the outcome generated by the ML model from one classification category to another classification category.

21. The add-on component of claim 20, wherein the outcome comprises at least one of:
(a) an undesired medical condition, the instructions are for treating the patient to change the outcome from the undesired medical condition to lack of the undesired medical condition by administering a medication to reduce the value of the identified at least one feature; and
(b) a prediction of likelihood of failure of an electrical and/or mechanical and/or computer system, wherein the plurality of features includes measurements of components of the system, and the instructions are for reducing risk of system failure by improving operation of a component having a measurement that most contributes to likelihood of failure of the system.

22. (canceled)

23. A method for interpreting an outcome of a ML model, comprising:
receiving a plurality of features and an outcome of the ML model generated in response to an input of the plurality of features,
wherein at least two of the plurality of features are correlated to each other by a covariance value above a threshold;
computing a respective contribution coefficient denoting an initial value, for each of the plurality of features;
analyzing the plurality of features to identify a certain feature with highest contribution coefficient indicative of a relative contribution of the certain feature to the outcome;
computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature;
iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature; and
providing the respective contribution coefficient for each of the plurality of features.

24. A computer program product for interpreting an outcome of a ML model comprising program instructions which, when executed by a processor, cause the processor to perform:
receiving a plurality of features and an outcome of the ML model generated in response to an input of the plurality of features,
wherein at least two of the plurality of features are correlated to each other by a covariance value above a threshold;
computing a respective contribution coefficient denoting an initial value, for each of the plurality of features;
analyzing the plurality of features to identify a certain feature with highest contribution coefficient indicative of a relative contribution of the certain feature to the outcome;
computing, for each respective feature of a subset of the plurality of features that are non-independent with respect to the certain feature, a respective subsequent value for the contribution coefficient by adjusting the respective initial value for the contribution coefficient of the respective feature according to a covariance with the contribution coefficient of the certain feature;
iterating the analyzing and the computing to compute a subsequent certain feature with highest contribution coefficient for the remaining plurality of features excluding the previous certain feature, and re-adjusting the respective contributing coefficient according to a covariance with the contribution coefficient of the subsequent certain feature; and
providing the respective contribution coefficient for each of the plurality of features.
